(19) United States
(12) Patent Application Publication
(10) Pub. No.: US 2009/0214912 A1
(43) Pub. Date: Aug. 27, 2009

(54) ELECTRONIC APPARATUS

(75) Inventor: Toshio HORIGUCHI, Tokyo (JP)

Correspondence Address: Frishauf, Holtz Goodman & Chick, P.C., 16th Floor, 220 Fifth Avenue, New York, NY, 10001-7708, US

(73) Assignee: Olympus Corporation, Tokyo (JP)

(21) Appl. No.: 12/431,186

(22) Filed: Apr. 28, 2009

Related U.S. Application Data
(63) Continuation of application No. PCT/JP2007/071130, filed on Oct. 30, 2007.

(30) Foreign Application Priority Data
Oct. 31, 2006 (JP) 2006-297059

(51) Int. Cl. H01M 8/04

(52) U.S. Cl. 429/22

(57) ABSTRACT

A first battery includes a secondary battery which is rechargeable by a fuel cell. A second battery does not perform all the operations of an electronic apparatus but supply an electric power to enable operations of a battery residual quantity detection unit, which detects battery residual quantities of the fuel cell and the batteries, and a second display which display based on the detection result. On the basis of the detection result, the presence/absence of execution of a charging operation from the fuel cell to the first battery is determined, and a designation to supply fuel to the fuel cell and/or an operation state of the electronic apparatus is displayed on a first display. When the battery residual quantity of the fuel cell and/or the first battery is zero, an electric power is supplied from the second battery to the battery residual quantity detection unit and the second display.

### CROSS REFERENCE TO RELATED APPLICATIONS

This is a Continuation Application of PCT Application No. PCT/JP2007/071130, filed Oct. 30, 2007, which was published under PCT Article 21(2) in Japanese.

This application is based upon and claims the benefit of priority from prior Japanese Patent Application No. 2006-297059, filed Oct. 31, 2006, the entire contents of which are incorporated herein by reference.

### BACKGROUND OF THE INVENTION

1. Field of the Invention

The present invention relates to an electronic apparatus which uses both a fuel cell which generates electricity by chemical reaction of a fuel such as methanol or hydrogen and a secondary battery such as a rechargeable lithium-ion battery as power supplies.

2. Description of the Related Art

A mobile information device such as a cellular telephone, a PDA, or a digital camera has mainly used a rechargeable secondary battery such as a lithium-ion battery as a power supply. In recent years, to comply with a demand for enhanced functionality, multi-functionality, high-speeding and long-term driving of these devices, a small-sized fuel cell is expected as a new power supply. Some small-sized fuel cells have begun to be manufactured and used as a trial.

Unlike a conventional secondary battery, the fuel cell does not require an electric charging operation. The device can be instantaneously set in a long-time operation state only by supplying a fuel or exchanging fuel cartridges. Of these fuel cells, a fuel cell using methanol as a fuel can supply a constant output for a long period of time due to its characteristic. However, an output depending on a load state of a device to be used cannot be supplied. In particular, a device such as a cellular telephone or a digital camera has a plurality of modes. Depending on the modes, a fuel cell cannot be singularly used for a device which requires outputs one of which is twice or more the other output.

Therefore, when a fuel cell is to be used in the electronic apparatus, both a lithium-ion secondary battery or the like which can cope with a fluctuation in load and can be electrically charged and a fuel cell are generally used.

For example, in U.S. Pat. No. 7,216,246, as a power supply system used when a personal computer (to be referred to as a PC hereinafter) is used with a fuel cell, a system using both a fuel cell and a secondary battery is disclosed.

U.S. Patent Application Publication No. 2004/0212345 discloses a system in which power supplies to supply power to a PC are automatically switched depending on installation states and operation states of the PC.

Jpn. Pat. Appln. KOKAI Publication No. 2004-120887 discloses a digital camera in which a power supply to be used is switched to one of three power supplies, i.e., a fuel cell, a nickel-hydrogen battery, and a lithium coin battery depending on operation modes.

### BRIEF SUMMARY OF THE INVENTION

According to an aspect of the present invention, there is provided an electronic apparatus comprising:

a fuel cell;

a first battery including a secondary battery configured to be rechargeable by the fuel cell, all operations of the electronic apparatus being performed by an electric power supplied from at least one of the fuel cell and the first battery;

a second battery configured to do not perform all the operations of the electronic apparatus but at least supply an electric power to enable detect battery residual quantities of the fuel cell and the batteries and display based on the detection result; and

a battery residual quantity detection unit configured to detect the battery residual quantities of the fuel cell and the first and second batteries, wherein

on the basis of the battery residual quantities detected by the battery residual quantity detection unit, the presence/absence of execution of a charging operation from the fuel cell to the first battery is determined, and at least one of a designation to supply fuel to the fuel cell and an operation state of the electronic apparatus is displayed on a first display, and

when the battery residual quantity of at least one of the fuel cell and the first battery is zero, an electric power is supplied from the second battery to the battery residual quantity detection unit to detect the battery residual quantities of the fuel cell and the batteries, and display based on the detection result is performed on a second display.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a main configuration of a digital camera serving as an electronic apparatus according to a first embodiment of the present invention.

FIG. 2 is a block diagram showing a detailed configuration which supplies an electric power to a power supply monitor controller.

FIG. 3A is a rear view of the digital camera.

FIG. 3B is a side view of the digital camera.

FIG. 4 is a diagram showing a principle of measurement of a residual fuel quantity in a fuel tank measured by a sensor array, with the fuel tank viewed vertically from above.

FIG. 5 is a diagram showing a configuration of the sensor array.

FIG. 6 is a diagram showing an output of the sensor array.

FIG. 7 is a diagram showing a list of correspondence between states of the digital camera corresponding to states of residual quantities of fuel cell and batteries in the first embodiment and displays of the residual quantities.

FIG. 8 is a state transition diagram showing a mutual transition state between states of case 1 to case 12 in FIG. 7.

FIG. 9 is a diagram showing an operational flow chart of a power supply monitor controller and a system controller in the digital camera according to the first embodiment.

FIG. 10 is a diagram showing a main configuration of a digital camera serving as an electronic apparatus according to a second embodiment of the present invention.

FIG. 11 is a diagram showing a list of correspondence between states of the digital camera corresponding to states of residual quantities of fuel cell and batteries in the second embodiment and displays of the residual quantities.

FIG. 12 is a state transition diagram showing a mutual transition state between states of case 1 to case 12 in FIG. 11.

FIG. 13 is a diagram showing an operation flow chart of a power supply monitor controller and a system controller in the digital camera according to the second embodiment.

### DETAILED DESCRIPTION OF THE INVENTION

Best modes for carrying out the present invention will be described below with reference to the accompanying drawings.

### First Embodiment

As a first embodiment of the present invention, an electronic apparatus which uses a secondary battery as a main power supply and operates while causing a fuel cell to electrically charge the secondary battery.

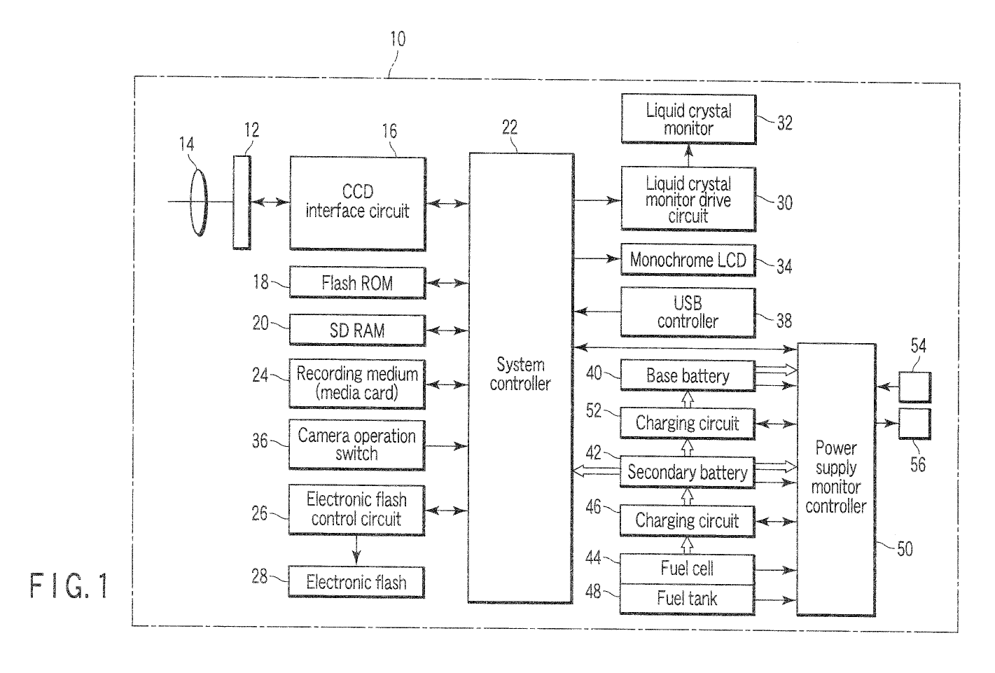

As shown in FIG. 1, a digital camera 10 serving as an electronic apparatus according to the embodiment includes a charge coupled device (CCD) 12; a photographing lens 14; a CCD interface circuit 16; a Flash ROM 18; a synchronous DRAM (SDRAM) 20; a system controller 22, a recording medium (media card) 24; an electronic flash control circuit 26; an electronic flash 28; a liquid crystal monitor drive circuit 30; a liquid crystal monitor 32; a monochrome LCD 34; a camera operation switch 36; a Universal Serial Bus (USB) controller 38; a base battery 40; a secondary battery 42; a fuel cell 44; a charging circuit 46; a fuel tank 48; a power supply monitor controller 50; a charging circuit 52; a power supply check switch 54; and a power supply check LED 56. In FIG. 1, a solid-thin arrow denotes a signal line, and a thick-white arrow denotes a supply of a power supply.

The CCD 12 photoelectrically converts an object image formed by the photographing lens 14 into an electrical signal (analog electrical signal). The CCD interface circuit 16 performs a predetermined image-pickup process to the electrical signal photoelectrically converted by the CCD 12 to obtain image data (digital electronic data) of a predetermined format.

In the Flash ROM 18, a control program to control an entire operation of the digital camera 10 and various data required to execute the control program are recorded. The SDRAM 20 is used to temporarily store image data obtained by the CCD interface circuit 16 and used as a work area or the like for the system controller 22. The system controller 22 reads and executes the control program recorded in the Flash ROM 18 to control the entire operation of the digital camera 10. The system controller 22 also performs predetermined image processing, compression/extension processes of image data, and the like.

The recording medium (media card) 24 is a recording medium such as a memory card or a small HDD (hard disk) which can be attached to or detached from the digital camera 10. The electronic flash control circuit 26 controls light emission of the electronic flash 28 on the basis of a designation from the system controller 22. The liquid crystal monitor drive circuit 30 drives the liquid crystal monitor 32, and the liquid crystal monitor 32 displays an image, various menus, and the like depending on driving by the liquid crystal monitor drive circuit 30. The monochrome LCD 34 displays a setting state of the digital camera 10. The camera operation switch 36 is a switch which includes a release switch, an REC mode switch, a PLAY mode switch, and the like to perform a predetermined designation. The USB controller 38 performs control to exchange data with an external apparatus (not shown) connected to the digital camera 10 through the USB scheme.

On the digital camera 10, power supplies of three types, i.e., the base battery 40, the secondary battery 42, and the fuel cell 44 are mounted.

The secondary battery 42 is a battery such as a lithium-ion secondary battery or a nickel-hydrogen battery which can be reused by electric charging. In the digital camera 10, normally, the secondary battery 42 is used as a main power supply for the digital camera 10 in a state in which the secondary battery 42 is charged by the fuel cell 44 through the charging circuit 46. The fuel cell 44 does not cope with a peak current in a start-up state of the digital camera 10, an emitting state of the electronic flash, a continuous photographing state, or the like. For this reason, the fuel cell 44 is not used as the main power supply for the digital camera 10 but functions only to charge the secondary battery 42. Therefore, an output from the fuel cell 44 charges the secondary battery 42 through the charging circuit 46 and is not connected to the system controller 22.

In the fuel cell 44, as a passive fuel cell which is small-sized because the fuel cell is mounted on a mobile apparatus and which does not require auxiliary machines, a direct-methanol fuel cell (DMFC) using methanol as a fuel, a hydrogen fuel cell (PEMFC), or the like can be used. On the fuel cell 44, a fuel tank 48 which stores a fuel is mounted. A fuel is directly added to the fuel tank 48 to make it possible to instantaneously supply the fuel. Alternatively, as a scheme which exchanges and uses a fuel cartridge in place of a fuel tank, it is possible to instantaneously supply the fuel by exchanging the fuel cartridge.

The base battery 40 is an emergency power supply which performs a minimum operation when the secondary battery 42 does not function, for example, in an initial state, an uncharged state of the secondary battery 42, or an empty state of the secondary battery 42. In this case, the base battery 40 supplies a power to the power supply monitor controller 50. The base battery 40 is charged by the secondary battery 42 through the charging circuit 52 and configured by a secondary battery such as a lithium-ion secondary battery or a nickel-hydrogen battery. The base battery 40 can be operated as an emergency power supply when the level of a charge state is a predetermined level or higher.

The power supply monitor controller 50 monitors states such as residual quantities or voltages of the base battery 40, the secondary battery 42 and the fuel cell 44 and transmits the states to the system controller 22. The system controller 22 controls an entire operation of the digital camera 10 on the basis of the information and displays necessary information to transmit the information to a user. Both the base battery 40 and the secondary battery 42 are connected to the power supply monitor controller 50. The power supply monitor controller 50 is configured to function when any one of the batteries has a residual quantity.

The power supply check switch 54 connected to the power supply monitor controller 50 is a switch to check a state of the power supply for the digital camera 10. When the power supply check switch 54 is turned on by a user, the power supply monitor controller 50 checks the states of the base battery 40, the secondary battery 42 and the fuel cell 44, and displays results on the power supply check LED 56.

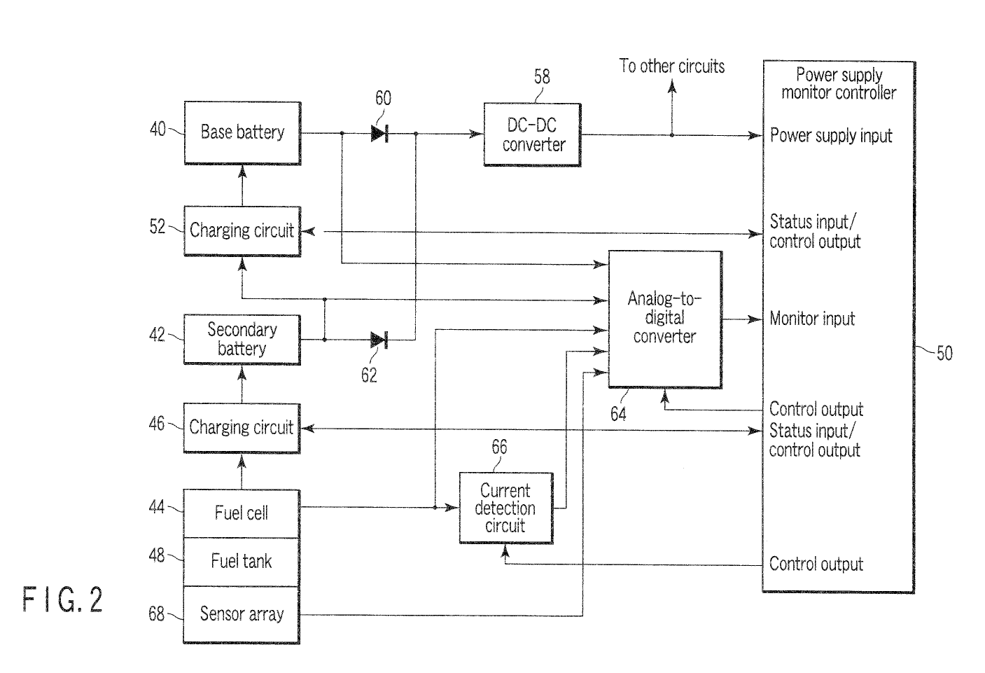

Details of a power supply to the power supply monitor controller 50 will be described below with reference to FIG. 2.

More specifically, the output of the base battery 40 is connected to a DC-DC converter 58 through a back-flow preventing diode 60, and the output of the secondary battery 42 is connected to the DC-DC converter 58 through a back-flow preventing diode 62. The DC-DC converter 58 converts output voltages from the base battery 40 and the secondary battery 42 which fluctuate depending on battery residual quantities into voltages required by the power supply monitor controller 50, and supplies the converted voltages. With this configuration, if any one of the base battery 40 and the secondary battery 42 has a residual quantity of a minimum level required to operate the power supply monitor controller 50, the power supply monitor controller 50 can be operated. The output of the secondary battery 42 is connected to the base battery 40 through the charging circuit 52, and always charges the base battery 40.

The power supply monitor controller 50 monitors an output voltage from the base battery 40 and an output from the secondary battery 42 as digital data through an analog-to-digital converter 64. The analog-to-digital converter 64 has a plurality of input channels which are switched by a control output signal from the power supply monitor controller 50.

On the other hand, with respect to an output from the fuel cell 44, a signal obtained by converting a current flowing in a load by a current detection circuit 66 into a voltage is connected to the input channel of the analog-to-digital converter 64 and monitored as digital data. At the same time, an output voltage of the fuel cell 44 is also monitored as digital data by the power supply monitor controller 50 through the analog-to-digital converter 64. Furthermore, a sensor array 68 is attached to the fuel tank 48 which stores a fuel used in the fuel cell 44. An output signal from the sensor array 68 is converted into digital data by the analog-to-digital converter 64 and monitored by the power supply monitor controller 50.

A method of monitoring battery states will be described below.

When a lithium-ion secondary battery is used as the secondary battery 42, the output voltage from the secondary battery 42 is monitored to make it possible to monitor the charge state of the secondary battery 42. This is because the lithium-ion secondary battery generally has a characteristic that an output voltage drops according to discharging, and thus the output voltage is measured to make it possible to estimate a residual quantity. When the output voltage is a predetermined voltage (in general, 3.0 volts), it is determined that the residual quantity of the secondary battery becomes empty.

When a nickel-hydrogen secondary battery is used as the secondary battery 42, a residual quantity can be estimated by a differential voltage between an output voltage from the secondary battery 42 obtained when a predetermined load is applied to the secondary battery 42 and an output voltage obtained before the load is applied to the secondary battery 42. As the predetermined load, for example, in the digital camera 10, a distance measuring preparation operation for an autofocusing operation or a charging operation of the electronic flash 28 is performed. When the level of the voltage obtained when the load is applied is a predetermined level or lower, it is determined that the residual quantity of the secondary battery is not enough for the electronic apparatus to operate.

On the other hand, in general, unlike in the secondary battery 42, the output voltage is not concretely associated with the residual quantity in the fuel cell 44. More specifically, the output voltage from the fuel cell 44 is constant as long as a fuel remains, and is not associated with quantity of a fuel. However, since the fuel cell 44 is to convert chemical energy held by the fuel into electrical energy at certain efficiency, a residual quantity can be estimated by subtracting consumed energy from energy in a fill-up state. More specifically, in FIG. 2, an output voltage from the fuel cell 44 and an output current obtained through the current detection circuit 66 are measured at intervals of a predetermined period of time ΔT, and the output voltage and the output current are converted into digital data by the analog-to-digital converter 64. The digital data are then input to the power supply monitor controller 50. In the power supply monitor controller 50, a product of the output voltage and the output current is calculated to calculate the electric power. When the resultant value is multiplied by the measurement time interval ΔT, the energy used during the period of time ΔT can be measured. The energies are accumulated from time when the fuel cell 44 begins to be used to make it possible to calculate a cumulative amount of energy used up to now. When the energy amount is subtracted from a total energy amount obtained when the fuel tank 48 is full, a residual quantity can be calculated. When the residual quantity is zero, residual fuel is zero. When the empty fuel tank 48 is filled with fuel until the fuel tank 48 is filled up, or when the fuel cartridge is exchanged with a new fuel cartridge filled up with fuel in a cartridge exchange system, a fill-up state is obtained.

Unlike in the above method, when the fuel is liquid such as methanol, a method of more directly measuring a fuel quantity by using the sensor array 68 is used, which will be described below.

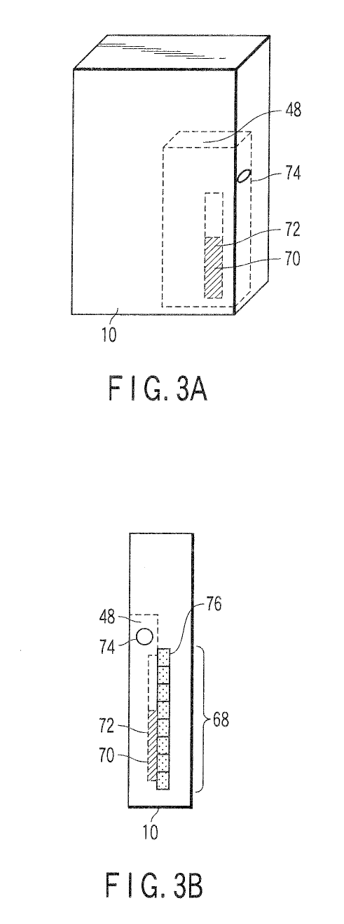

As shown in FIGS. 3A and 3B, a fuel quantity display window 70 is arranged on the fuel tank 48 to make it possible to optically detect a fuel 72 in the fuel tank 48. On a side surface of the digital camera 10, a fuel supply port 74 to supply the fuel 72 is arranged. In the digital camera 10, the sensor array 68 obtained by arranging a plurality of sensors 76 is arranged at a position corresponding to the fuel quantity display window 70 on the fuel tank 48.

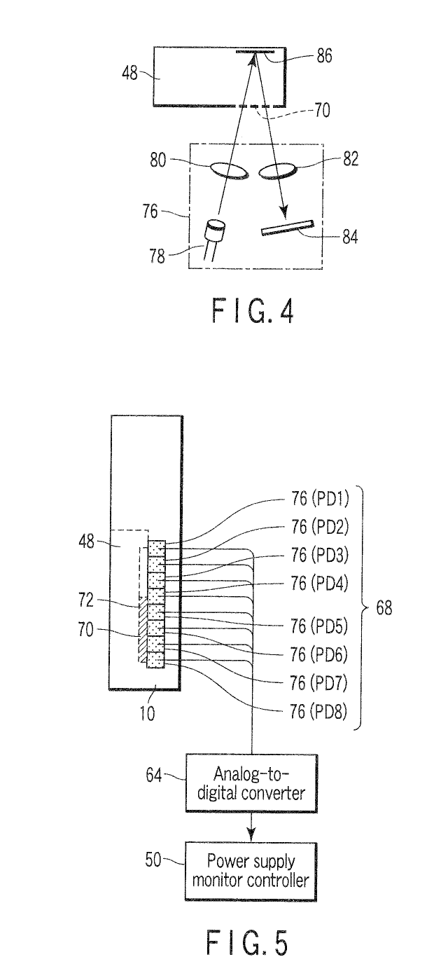

The sensor 76 is configured by, as shown in FIG. 4, an LED 78, a condenser lens 80, an imaging lens 82, and a detector 84. A mirror unit 86 is arranged in the fuel tank 48. The fuel quantity display window 70 partially consists of a transparent material such as an acrylic resin or glass and faces the sensor 76. Therefore, light emitted from the LED 78 is focused by the condenser lens 80 and irradiates the inside of the fuel tank 48 through the fuel quantity display window 70. The mirror unit 86 serving as a portion facing the fuel quantity display window 70 inside the fuel tank 48 is plated with a high-reflectance metal such as silver or nickel. Therefore, when no fuel is present in the fuel tank 48, almost all lights are reflected by the mirror unit 86 and detected by the detector 84 through the fuel quantity display window 70 and the imaging lens 82. For this reason, an output from the detector 84 is at a high level.

On the other hand, when a fuel is present in the fuel tank 48, light emitted from the LED 78 is refracted when the light passes through the fuel 72. For this reason, the light is incident on the fuel tank 48 at an angle different from that obtained when no fuel is present in the fuel tank 48, and the light is outgoing at the different angle even after the light is reflected by the mirror unit 86. Therefore, the intensity of the light reaching the detector 84 is low. As a result, an output from the detector 84 is low-level.

On the basis of the principle, it can be detected whether the fuel 72 is present at an arbitrary position in the fuel tank 48.

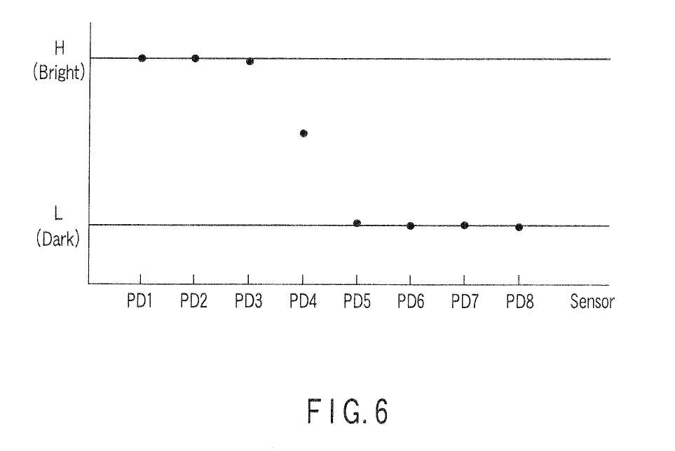

The plurality of sensors 76 are arranged in vertical directions of the digital camera 10 (directions perpendicular to the paper surface in FIG. 4) to make it possible to measure a residual quantity of the fuel 72 at a high accuracy. When the LED 78, the condenser lenses 80 and 82, and the detector 84 are arranged in the form of an array, good space efficiency can be obtained. This array is the sensor array 68. The configuration of the sensor array 68 is shown in FIG. 5, and an output from the sensor array 68 is shown in FIG. 6.

In the example shown in FIG. 5, the sensor array 68 is obtained by the same 8 sensors as the sensor 76 being arranged in parallel, and outputs from the sensors 76 are input to the analog-to-digital converter 64 as outputs PD1, PD2, . . . , PD8, respectively. An output from the analog-to-digital converter 64 is input to the power supply monitor controller 50. For descriptive convenience, the analog-to-digital converter 64 and the power supply monitor controller 50 seem to be arranged outside the digital camera 10. However, these components are actually arranged inside the digital camera 10.

FIG. 6 is a graph of the outputs PD1 to PD8. In the state shown in FIG. 5, since the fuel 72 is present halfway through the PD4, the outputs PD1 to PD3 are at high levels (H), the outputs PD5 to PD8 are at low-levels (L), and the output PD4 is at an intermediate level between the high level and the low level. By the sensor outputs, the power supply monitor controller 50 can detect that the fuel 72 is at an intermediate level between levels of ⅜ and 4/8 of the fuel tank 48. When all the sensor outputs of the sensor array 68 are at low levels, this state indicates that the fuel tank 48 is filled up with the fuel 72. When all the sensor outputs of the sensor array 68 are at high levels, this state indicates that the fuel tank 48 is empty.

In this fuel detecting method, the digital camera 10 must be placed in a direction shown in FIG. 3A. For this reason, instructions indicating that the digital camera 10 should be placed in the direction shown in FIG. 3A must be written on the exterior of the digital camera 10.

In the example in FIG. 5, a region for detecting residual quantity of the fuel tank 48 are divided into 8 regions. However, the number of regions is not limited to 8.

When the power supply check switch 54 is turned on by a user, the power supply monitor controller 50 checks the states of the base battery 40, the secondary battery 42, and the fuel cell 44 and displays the results on the power supply check LED 56. When the residual quantities of both the base battery 40 and the secondary battery 42 are zero, the power supply check LED 56 is turned off. It is assumed that the residual quantities of the base battery 40 and the secondary battery 42 are not zero, the fuel of the fuel cell 44 remains, and the digital camera 10 can be operated. In this case, the power supply check LED 56 is turned on. States other than the turn-off state and the turn-on state will be described later in the explanation of the operation of the digital camera 10.

In the embodiment, a user interface which causes a user to recognize the digital camera 10 as a camera which is operated by the fuel cell 44 and does not cause the user to regard the presence of the secondary battery 42 can be obtained.

The operation of the digital camera 10 as an electronic apparatus according to the embodiment, in accordance with the residual states of the battery, will be described below.

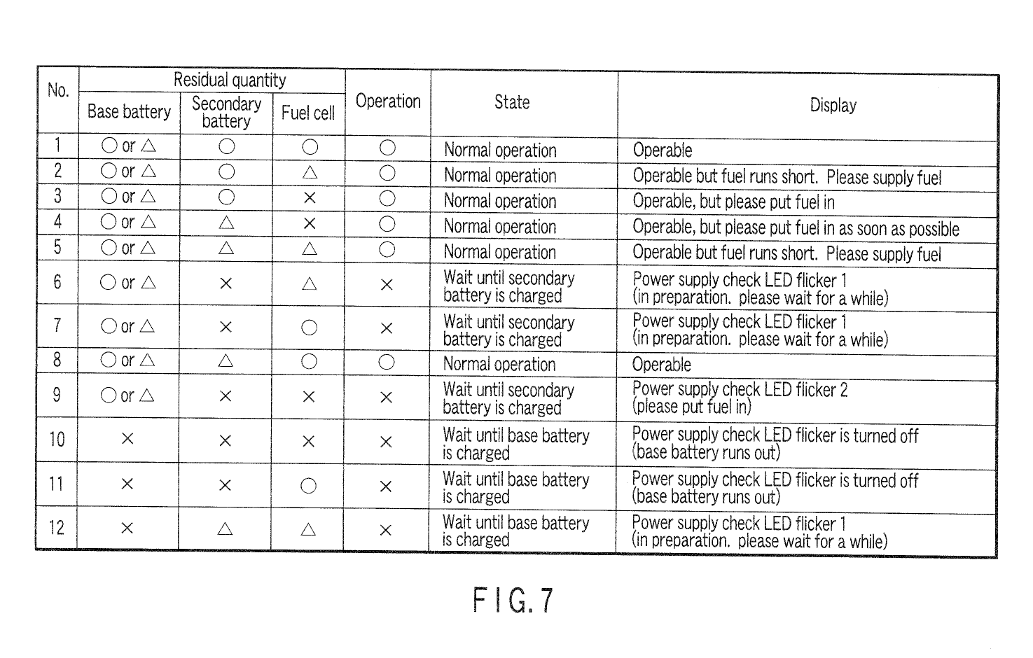

FIG. 7 shows a list of correspondence between states of the digital camera 10 corresponding to states of residual quantities of the fuel cell and the batteries and displays of the residual quantities. FIG. 7 shows the states of the residual quantities of the fuel cell and the batteries, the operability of a camera operation, states of the operable camera, and display contents on the liquid crystal monitor 32 in 12 cases 1 to 12. In FIG. 7, ◯ in a column showing a residual quantity (remaining quantity) denotes “full-charge” or “fill-up”, X denotes “empty”, and Δ denotes an intermediate state between the states ◯ and X (fuel or electric power is consumed in the full-charge or “full-up” state, but the fuel cell or the battery is not empty). This intermediate state is called a “charge quantity reduced state” in the secondary battery 42, and is called a “fuel reduced state” in the fuel cell 44. Since “◯ or Δ” denotes state in which a residual quantity of the battery is not empty, i.e., a state in which electric power is reduced from a full-charge state but not reduced to an empty state. This is called a “charge state”. The display contents in the drawing are shown as an example, and other display contents may be used.

The states of case 1 to case 12 will be described below.

Case 1 is the case in which the base battery 40 is in a charge state, the secondary battery 42 is fully charged, and the fuel cell 44 is filled up with fuel. In case 1, the digital camera 10 can normally operate. Therefore, for example, “Operable” is displayed on the liquid crystal monitor 32. When the digital camera 10 operates in this state, the secondary battery 42 is used. For this reason, the secondary battery 42 is charged by the fuel cell 44. When the base battery 40 is not fully charged, a charging operation is performed by the secondary battery 42.

Case 2 is the case in which the base battery 40 is in a charge state, the secondary battery 42 is fully charged, and the fuel cell 44 is in the fuel reduced state. In case 2, since the secondary battery 42 is in the full-charge state, the digital camera 10 can normally operate. When a charge quantity of the secondary battery 42 gradually reduces by operating the digital camera 10, the fuel cell 44 is set in an electric power generation state to charge the secondary battery 42. For this reason, the fuel of the fuel cell 44 further reduces. Therefore, in order to prevent the fuel cell 44 from running out of fuel, as a warning which urges a user to add fuel, for example, a warning “Operable, but fuel runs short; please add fuel” is displayed on the liquid crystal monitor 32.

Case 3 is the case in which the base battery 40 is in a charge state, the secondary battery 42 is fully charged, and the fuel of the fuel cell 44 is empty. Since the secondary battery 42 is fully charged, the digital camera 10 can normally operate. However, since the fuel of the fuel cell 44 is empty, a warning “operable, but please put fuel in” is displayed on the liquid crystal monitor 32 to urge a user to supply the fuel.

Case 4 is the case in which the base battery 40 is in a charge state, the secondary battery 42 is a charge quantity reduced state, and the fuel of the fuel cell 44 is empty. In case 4, as in case 3, the digital camera 10 can normally operate. However, since the charge quantity of the secondary battery 42 is reduced, the secondary battery 42 must be early charged to prevent the battery from being shut off. In this case, since the fuel cell 44 which charges the secondary battery 42 is empty, a charging operation for the secondary battery 42 cannot be performed. Therefore, for example, a warning “Operable, but please put fuel in as soon as possible” is displayed on the liquid crystal monitor 32 to urge a user to supply fuel.

Case 5 is the case in which the base battery 40 is in a charge state, the secondary battery 42 is in a charge quantity reduced state, and the fuel cell 44 is in a fuel reduced state. In case 5, since a charge quantity remains in the secondary battery 42, the digital camera 10 can normally operate. Since fuel remains in the fuel cell 44, the fuel cell 44 generates electricity to make it possible to charge the secondary battery 42. The secondary battery 42 can also be charged by the fuel cell 44 while operating the digital camera 10. However, since the fuel used in the fuel cell 44 is reduced, for example, a warning “Operable but fuel runs short. Please supply fuel.” is displayed on the liquid crystal monitor 32.

Case 6 is the case in which the base battery 40 is in a charge state, the secondary battery 42 is empty, and the fuel cell 44 is in a fuel reduced state. In case 6, since the secondary battery 42 is empty, the digital camera 10 cannot operate. However, since the fuel still remains in the fuel cell 44, the fuel cell 44 generates electricity to make it possible to charge the secondary battery 42. For this reason, when the charge quantity of the secondary battery 42 is at a predetermined level, i.e., a charge level at which the digital camera 10 can be operated, the digital camera 10 is operable. The charge level is determined in consideration of operation characteristic of the digital camera 10 in advance, and is configured to be controlled by the power supply monitor controller 50 (the system controller 22 cannot be operated because the secondary battery 42 is empty). Whether the secondary battery 42 is charged to the predetermined level is checked by checking an output voltage from the secondary battery 42.

Until the secondary battery 42 is charged to the predetermined level, a user must wait. However, since the secondary battery 42 is empty, the system controller 22 cannot be operated. For this reason, a display operation cannot be performed on the liquid crystal monitor 32. Therefore, in order to notify the user of the state of the power supply for the digital camera 10, the power supply check switch 54 and the power supply check LED 56 are used. More specifically, in this state, when the power supply monitor controller 50 detects that the user has turned on the power supply check switch 54, the power supply check LED 56 is flickered in a cycle in which an on-off ratio is 1:1. This flicker is called “LED flicker 1”. It is written in the instruction of the digital camera 10 or presented on a sticker or the like on a part of the digital camera 10 body that the 1:1 flicker is a message which means that “In preparation. Please wait for a while” to notify the user of it. The power supply check LED 56 is turned on by an electric power of the base battery 40.

Thereafter, when the fuel cell 44 begins to generate electricity, the fuel cell 44 charges the secondary battery 42. When a charge state of the secondary battery 42 is at a predetermined level, the system controller 22 operates to make it possible to display a state of the power supply for the digital camera 10 on the liquid crystal monitor 32. For this reason, this state is transitional for the meanwhile.

Case 7 is the case in which the base battery 40 is in a charge state, the secondary battery 42 is empty, and the fuel of the fuel cell 44 is filled up with fuel. In case 7, as in case 6, since the secondary battery 42 is empty, the digital camera 10 cannot be operated. However, since the fuel cell 44 generates electricity, when the charge quantity of the secondary battery 42 is at the predetermined level, the digital camera 10 can be operated. The user must wait until then. Thus, as in case 6, when the user turns on the power supply check switch 54 by using the power supply check switch 54 and the power supply check LED 56, the power supply check LED 56 is flickered in a cycle in which an on-off ratio is 1:1 to notify the user of a message meaning that “In preparation. Please wait for a while”.

Case 7 is different from case 6 in that the fuel cell 44 is filled up with fuel.

Case 8 is the case in which the base battery 40 is in a charge state, the secondary battery 42 is in a charge quantity reduced state, and the fuel cell 44 is filled up with fuel. In case 8, since charge quantity remains in the secondary battery 42, the digital camera 10 can be normally operated. Since the fuel cell 44 is filled up with fuel, the fuel cell 44 generates electricity to charge the secondary battery 42. The secondary battery 42 can also be charged by the fuel cell 44 while operating the digital camera 10 by the secondary battery 42. Since the apparatus does not cause the user to regard the presence of the secondary battery 42, for example, “Operable” is displayed on the liquid crystal monitor 32.

Case 9 is the case in which the base battery 40 is in a charge state, the charge quantity of the secondary battery 42 is zero, and the fuel of the fuel cell 44 is empty. In case 9, in order to use the digital camera 10, fuel is added to the fuel cell 44, or an unused fuel cartridge is attached to operate the fuel cell 44 to generate electricity, and the secondary battery 42 must be charged by the electrical generating output. More specifically, the user must be urged to put fuel in the fuel cell 44. In this case, since the secondary battery 42 serving as the main power supply for the digital camera 10 is empty, display cannot be performed on the liquid crystal monitor 32. Therefore, as in cases 6 and 7, the power supply check switch 54 and the power supply check LED 56 are used for display. However, in this state, the power supply check LED 56 is designed to flicker in a cycle in which an on-off ratio is 2:1 when the power supply check switch 54 is turned on. This flicker is called “LED flicker 2”. It is written in the instruction of the digital camera 10 or presented on a part of the digital camera 10 body that the 2:1 flicker is a message which means that “please put fuel in” to notify the user of it.

Case 10 is the case in which all of the base battery 40, the secondary battery 42, and the fuel of the fuel cell 44 are empty. Case 10 is the case in which the digital camera 10 is left for a long period of time without being used, and the base battery 40 and the secondary battery 42 are naturally discharged. Since the base battery 40 is always charged by the secondary battery 42 in normal use, the state of case 10 rarely occurs. In this state, since the base battery 40 is also empty, the power supply check LED 56 is kept in an off state even though the power supply check switch 54 is turned on. It is written in the instruction of the digital camera 10 or presented on a part of the digital camera 10 body that the off state of the LED means that “base battery is shut off” to notify the user of it.

When the charge quantity of the base battery 40 is zero, even if the secondary battery 42 is attached while being fully charged, the digital camera 10 does not operate. Since the base battery 40 is a power supply to perform a minimum operation when the charge quantity of the secondary battery 42 is zero, the base battery 40 must be always charged to some extent. As countermeasures against the case, the base battery 40 is charged to the predetermined level by any one of (1) the base battery 40 is replaced with a charged base battery and (2) fuel is put in the fuel cell 44, and the fuel cell 44 is set in an electrical generation state to charge the secondary battery 42, after which the base battery 40 is charged. Whether the base battery 40 is charged to the predetermined level is checked by checking an output voltage from the base battery 40 as in the checking operation for the secondary battery 42. In 1, above, when the fuel of the fuel cell 44 is supplied, and the secondary battery 42 is charged by the fuel cell 44 to a predetermined level described in case 6, i.e., a charge level at which the digital camera 10 can operate, the digital camera 10 can be used. In 2, above, when the base battery 40 is charged, and the secondary battery 42 is charged to the predetermined level described in case 6, i.e., the charge level at which the digital camera 10 can be operated, the digital camera 10 is set in a usable state. The coping method is written on the instruction of the digital camera 10 or presented on a part of the digital camera 10 body to notify the user of the method.

Case 11 is the case in which both the base battery 40 and the secondary battery 42 are empty and the fuel cell 44 is filled up with fuel. Case 11 is a state in which the fuel of the fuel cell 44 is supplied in the state of case 10. The user must be kept waiting until the fuel cell 44 is operated to start electrical generation to charge the secondary battery 42 and the secondary battery 42 charges the base battery 40. Since the base battery 40 and the secondary battery 42 are empty, the power supply check LED 56 is kept in an off state. In this state, when the secondary battery 42 is charged, the state of the next case 12 is obtained.

Case 12 is the case in which the base battery 40 is empty, the secondary battery 42 is in a charge reduced state, and the fuel cell 44 is in a fuel reduced state. Case 12 is the case in which the fuel cell 44 generates electricity in the state of case 11 to charge the secondary battery 42 to some extent. Since the base battery 40 is empty, the digital camera 10 cannot be operated. The user must wait until the base battery 40 is charged to a predetermined level or higher by an electric power charged in the secondary battery 42. Whether the base battery 40 is charged to the predetermined level is checked by checking an output voltage from the base battery 40 as in the checking operation for the secondary battery 42.

Since display to be performed in this case cannot be operated by the system controller 22 because the base battery 40 is empty, the power supply check switch 54 and the power supply check LED 56 are used. As the power supply for the power supply monitor controller 50, as shown in FIG. 2, the secondary battery 42 is used. When the power supply check switch 54 is turned on, the power supply check LED 56 is flickered in a cycle in which an on-off ratio is 1:1 (“LED flicker 1”). The user is notified that this 1:1 flicker is a message which means that “In preparation. Please wait for a while” as described above.

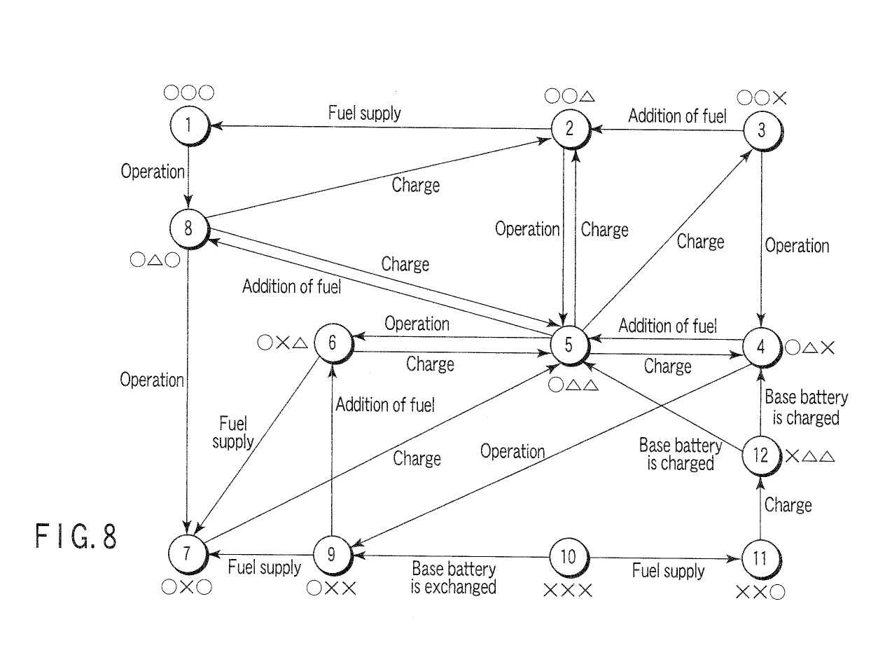

A mutual transition state between the states of case 1 to case 12 is shown in FIG. 8. In FIG. 8, encircled numbers correspond to case 1 to case 12, respectively. Symbols ◯, Δ, and X described beside the encircled numbers denote the state of the base battery 40, the state of the secondary battery 42, and the state of the fuel of the fuel cell 44, respectively. Words and terms written near arrows mean the followings.

“Operation” means that the digital camera 10 is operated.

“Charging” means that the fuel cell 44 charges the secondary battery 42.

“Addition of fuel” means that the fuel of the fuel cell 44 is added (before the fuel cell 44 is filled up). “Supply of fuel” means that the fuel cell 44 is filled up with fuel.

The system controller 22 performs control of selection of a battery to be used by the digital camera 10, display on the liquid crystal monitor 32, and the like on the basis of the state transition diagram and the states of the fuel cell and the batteries obtained from the power supply monitor controller 50.

For example, the state of case 5 will be exemplified. Since case 5 is ◯ΔΔ, the base battery 40 is fully charged, the secondary battery 42 is charged halfway, and the fuel of the fuel cell 44 remains. In this state, (A) when the digital camera 10 is used, the charge quantity of the secondary battery 42 reduces, and transition to the state (◯XΔ) of case 6 occurs. In contrast to this, (B) when fuel is supplied, the fuel cell 44 is filled up with fuel, and transition to the state (◯Δ◯) of case 8 occurs. Alternatively, (C) when the fuel cell 44 generates electricity to charge the secondary battery 42, depending on the charge state and a residual quantity of the fuel, transition to any one of the states of case 2 (◯◯Δ), case 3 (◯◯X), and case 4 (◯ΔX) occurs.

On the other hand, transition to the state of case 5 occurs through any one of the routes given by (a) the case in which a charge quantity of the secondary battery 42 reduces by using the digital camera 10 in the state of case 2 (◯◯Δ), (b) the case in which fuel is added in the state of case 4 (◯ΔX), (c) the case in which the fuel cell 44 generates electricity to charge the secondary battery 42 and fuel remains in the state of case 6 (◯XΔ), (d) the case in which the fuel cell 44 generates electricity to charge the secondary battery 42 and fuel remains in the state of case 7 (◯X◯), (e) the case in which the fuel cell 44 generates electricity to charge the secondary battery 42 and fuel remains in the state of case 8 (◯Δ◯), and (f) the case in which the fuel cell 44 generates electricity to charge the secondary battery 42 and the secondary battery 42 fully charges the base battery 40 in the state of case 12 (X◯◯).

The system controller 22, on the basis of the state transition diagram, controls an entire operation of the digital camera 10 by using an optimum power supply according to the states of the power supplies. When transition to a specific state occurs through a route which is not shown in the state transition diagram, some abnormality might have occurred in relation to the power supplies. In this case, the system controller 22 can cope with the abnormality.

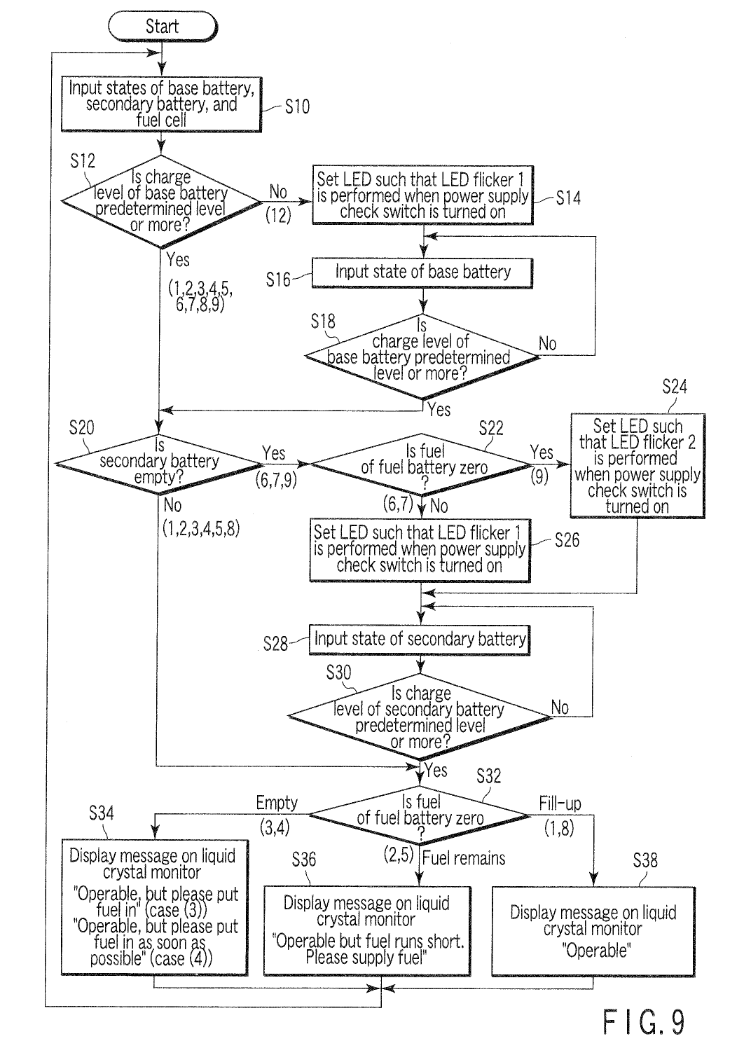

Operations of the power supply monitor controller 50 and the system controller 22 in the digital camera 10 serving as an electronic apparatus according to the embodiment will be described below in detail with reference to FIG. 9. Since the power supply monitor controller 50 operates by using the base battery 40 or the secondary battery 42 as a power supply, the states of case 10 and case 11 are excluded from the states shown in FIG. 7. Parenthetic numbers described in FIG. 9 correspond to the states shown in FIG. 7, respectively.

More specifically, the states of the base battery 40, the secondary battery 42, and the fuel of the fuel cell 44 are taken in first (step S10). It is checked whether the charge level of the base battery 40 is a predetermined level or more (step S12).

When it is determined that the charge level of the base battery 40 is not the predetermined level or more, the power supply monitor controller 50 operates by the secondary battery 42, but must wait for a charging operation for the base battery 40. This state is the state of case 12. In this case, the power supply check LED 56 is set to be flickered by “flicker 1” such that the user is notified of an in-preparation state when the power supply check switch 54 is turned on (step S14). Thereafter, the state of the base battery 40 is taken in (step S16), and it is determined whether the charge state of the base battery 40 is at a predetermined level or more (step S18). In this case, when it is determined whether the charge state is not at the predetermined level or more, the power supply monitor controller 50 returns to step S16. In this manner, the power supply monitor controller 50 waits until the charge state of the base battery 40 is at the predetermined level or more.

When it is determined in step S18 that the charge state of the base battery 40 is at the predetermined level or more, or when it is determined in step S12 that the charge state of the base battery 40 is at the predetermined level or more (corresponding to the states of cases 1, 2, 3, 4, 5, 6, 7, 8, and 9), it is further checked whether the charge state of the secondary battery 42 taken in step S10 is empty (step S20). In this case, when it is determined that the secondary battery 42 is empty (corresponding to the state of case 6, 7, or 9), a setting must be performed such that a user can be notified that the user waits until the secondary battery 42 is charged by the fuel cell 44. Therefore, the fuel of the fuel cell 44 taken in step S10 is checked (step S22). When it is determined that the fuel of the fuel cell 44 is empty (corresponding to the state of case 9), the power supply check LED 56 is set to be flickered by “flicker 2” to request the user to supply fuel when the power supply check switch 54 is turned on (step S24). In contrast to this, when it is determined in step S22 that the fuel of the fuel cell 44 is not empty (corresponding to the state of case 6 or 7), the power supply check LED 56 is set to be flickered by “flicker 1” to notify the user of an in-preparation state when the power supply check switch 54 is turned on (step S26). When the setting of the flicker mode of the power supply check LED 56 in step S24 or step S26 is ended, the state of the secondary battery 42 is taken in (step S28), and it is determined whether the charge state of the secondary battery 42 is at a predetermined level or more (step S30). In this case, when it is determined that the charge state is not at the predetermined level or more, the power supply monitor controller 50 returns to step S28. In this manner, the power supply monitor controller 50 waits until the charge state of the secondary battery 42 is at the predetermined level or more.

When it is determined in step S30 that the charge state of the secondary battery 42 is at the predetermined level or more, or when it is determined in step S20 that the secondary battery 42 is not empty (corresponding to the states of cases 1, 2, 3, 4, 5, and 8), fuel quantities of the fuel cell 44 taken in step S10 is checked (step S32), and corresponding messages are displayed on the liquid crystal monitor 32 according to the quantities. More specifically, when the fuel is empty (corresponding to the states of cases 3 and 4), “Operable, but please put fuel in” (case 3) or “Operable, but please put fuel in as soon as possible” (case 4) is displayed (step S34). In contrast to this, when the fuel cell 44 is not filled up but fuel remains (corresponding to the states of cases 2 and 5), “Operable but fuel runs short. Please supply fuel.” is displayed (step S36). When the fuel cell 44 is filled up with fuel (corresponding to the states of cases 1 and 8), “Operable” is displayed (step S38). After the display is performed, the power supply monitor controller 50 returns to step S10 to perform operations corresponding to the states of the base battery 40, the secondary battery 42, and the fuel cell 44. At this time, it can be checked on the basis of the state transition diagram whether transition of the states occurs.

As described above, according to the first embodiment, in an electronic apparatus such as the digital camera 10 using the fuel cell 44 and the rechargeable secondary battery 42 as power supplies, an operation of the electronic apparatus and a power supply to be used are selected depending on the states of the fuel cell 44 and the secondary battery 42, and, at the same time, a message based on the states of the fuel cell 44 and the secondary battery 42 is displayed. Furthermore, even when both the fuel cell 44 and the secondary battery 42 cannot be operated, in addition to the fuel cell 44 and the secondary battery 42, the base battery 40 serving as a rechargeable emergency power supply to perform a minimum operation and the power supply monitor controller 50 and the power supply check LED 56 serving as emergency information display means are arranged, and the emergency power supply is configured to be always charged while the electronic apparatus operates. Therefore, the electronic apparatus can be efficiently operated. Furthermore, since a user can always know the states of the power supplies of the electronic apparatus, an appropriate countermeasure can be performed to make it possible to prevent the electronic apparatus from being unusable halfway due to battery shutoff.

### Second Embodiment

As a second embodiment of the present invention, an electronic apparatus which uses a fuel cell as a main power supply and causes a secondary battery to operate to compensate for a peak load will be described below. In the embodiment, when the fuel cell does not generate electricity, the electronic apparatus does not operate.

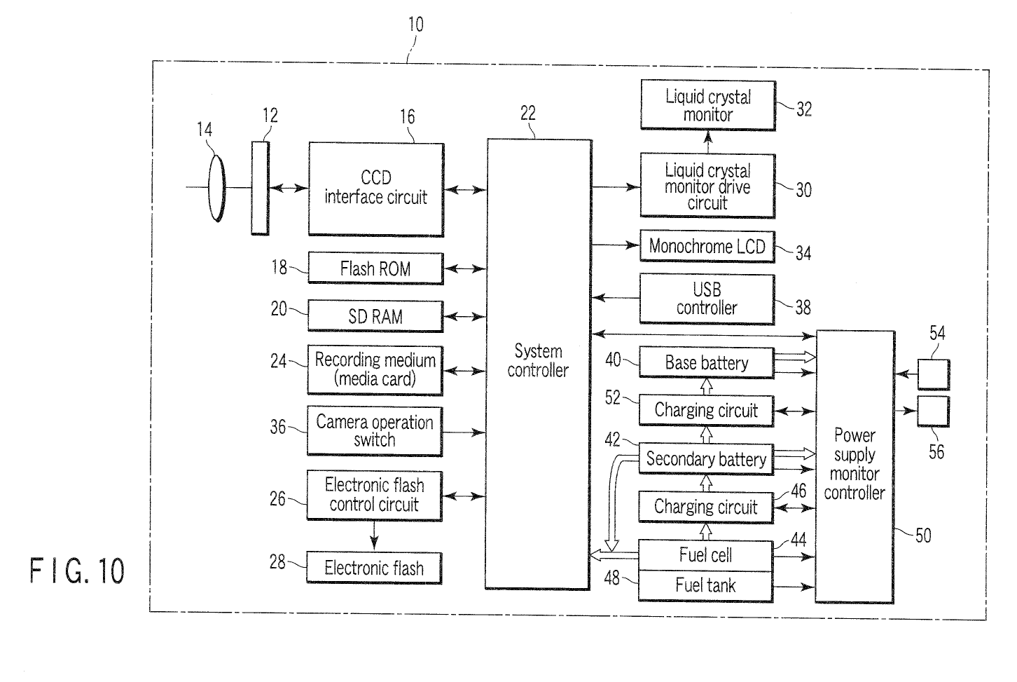

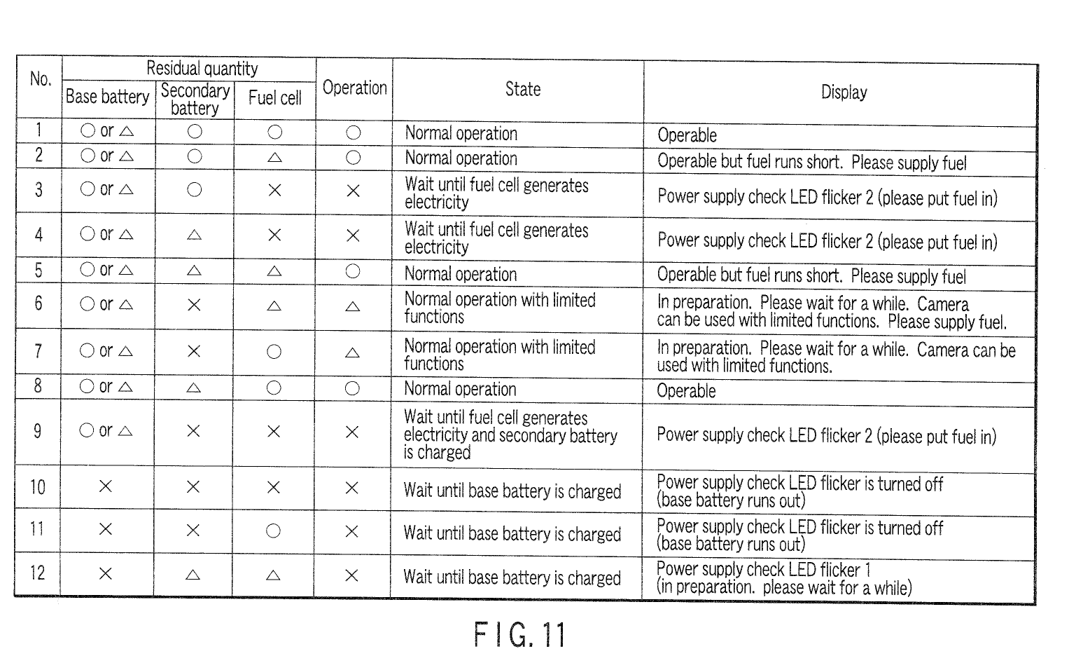

As shown in FIG. 10, the digital camera 10 in the embodiment has almost the same configuration as that in the first embodiment. However, the digital camera 10 in the second embodiment is different from that in the first embodiment in relationships between the secondary battery 42, the fuel cell 44, and the charging circuit 46. More specifically, the configuration in which the secondary battery 42 is charged by an output from the fuel cell 44 through the charging circuit 46 is the same as that in the first embodiment. However, to a main power supply for the digital camera 10, i.e., to a main power supply for the system controller 22, an output from the secondary battery 42 is supplied in addition to the output from the fuel cell 44. In this configuration, the digital camera 10 can be operated only by the fuel cell 44 in an operation such as a menu display operation or an image display operation which does not require a peak electric power. However, in a state such as a start-up state, an emitting state of the electronic flash, or a continuous photographing state which requires a peak electric power, the secondary battery 42 covers the shortfall. The other configurations are the same as those in the first embodiment.

A detailed block diagram of a periphery of the power supply monitor controller 50 is the same as FIG. 2 used in the explanation of the first embodiment.

In the embodiment, a user interface which causes a user to recognize the digital camera 10 as a camera which is operated by the fuel cell 44 and does not cause the user to regard the presence of the secondary battery 42 can be obtained.

The operation of the digital camera 10 as an electronic apparatus according to the embodiment, in accordance with the residual states of the battery, will be described below.

FIG. 11 corresponds to FIG. 7 in the first embodiment. The states of case 1 to case 12 in the second embodiment will be explained.

Case 1 is the case in which the base battery 40 is in a charge state, the secondary battery 42 is fully charged, and the fuel cell 44 is filled up with fuel. In case 1, since the fuel cell 44 is filled up with fuel and the secondary battery 42 is fully charged, the digital camera 10 can be normally operated. Therefore, for example, “Operable” is displayed on the liquid crystal monitor 32. In this state, when the digital camera 10 is operated, the secondary battery 42 and the fuel cell 44 are used. At this time, since the secondary battery 42 is charged by the fuel cell 44, the secondary battery 42 returns to a full-charge state. However, the fuel cell 44 is not filled up with fuel.

Case 2 is the case in which the base battery 40 is in a charge state, the secondary battery 42 is fully charged, and the fuel cell 44 is in the fuel reduced state. In this case 2, the fuel of the fuel cell 44 remains, and the secondary battery 42 is in a full-charge state. For this reason, the digital camera 10 can be normally operated. When the digital camera 10 is operated, the fuel of the fuel cell 44 further reduces. Therefore, in order to prevent the fuel cell 44 from running out of fuel, as a warning which urges a user to add fuel, for example, a warning “Operable, but fuel runs short; please add fuel” is displayed on the liquid crystal monitor 32.

Case 3 is the case in which the base battery 40 is in a charge state, the secondary battery 42 is fully charged, and the fuel of the fuel cell 44 is empty. Since the fuel of the fuel cell 44 is empty, the digital camera 10 cannot be operated. Fuel must be supplied to operate the digital camera 10, and the user must be notified of that fact. However, since the fuel of the fuel cell 44 is empty, display cannot be performed on the liquid crystal monitor 32 to urge the user to supply the fuel. On the other hand, since the base battery 40 and the secondary battery 42 are in full-charge states, the power supply monitor controller 50 can be operated. Therefore, in order to notify the user of the state of the power supply for the digital camera 10, the power supply check switch 54 and the power supply check LED 56 are used. More specifically, in this state, when it is detected by the power supply monitor controller 50 that the power supply check switch 54 is turned on by the user, the power supply check LED 56 is flickered in a cycle in which an on-off ratio is 2:1. It is written in the instruction of the digital camera 10 or presented on a sticker on a part of the digital camera 10 body that the 2:1 flicker is a message which means that “please put fuel in” to notify the user of it.

Thereafter, when fuel is supplied, the fuel cell 44 begins to generate electricity, and the digital camera 10 is in a usable state. For this reason, this state is transitional for the meanwhile.

Case 4 is the case in which the base battery 40 is in a charge state, the secondary battery 42 is a charge quantity reduced state, and the fuel of the fuel cell 44 is empty. In case 4, as in case 3, the digital camera 10 cannot be operated until fuel is supplied. Therefore, as in case 3, flicker of the power check LED 56 (flicker in a cycle in which an on-off ratio is 2:1) which means that “please put fuel in” is performed to urge the user to supply fuel as soon as possible.

Case 5 is the case in which the base battery 40 is in a charge state, the secondary battery 42 is in a charge quantity reduced state, and the fuel cell 44 is in a fuel reduced state. In case 5, since both the fuel of the fuel cell 44 and the charge quantity of the secondary battery 42 remain, the digital camera 10 can be normally operated. However, since fuel used in the fuel cell 44 reduces, a warning meaning that “Operable but fuel runs short. Please supply fuel.” is displayed on the liquid crystal monitor 32.

Case 6 is the case in which the base battery 40 is in a charge state, the secondary battery 42 is empty, and the fuel cell 44 is in a fuel reduced state. In case 6, although the fuel of the fuel cell 44 remains, since the secondary battery 42 is empty, none of the normal operations of the digital camera 10 can be performed. However, except for an operation such as an electronic flash emitting operation or a continuous photographing operation which requires a peak electric power, an operation such as a menu display operation, or a display operation of a photographed image on a liquid crystal monitor which does not require a peak electric power can be performed. More specifically, normal operations which are limited in function can be performed. Furthermore, when the fuel cell 44 is in an electricity generation state to charge the secondary battery 42 to obtain a predetermined charge level or more, all the normal operations can be performed. More specifically, the user must wait for a while until all the normal operations become possible. In addition, since the fuel of the fuel cell 44 is reduced, the user must be urged to fill fuel in the fuel cell 44.

In order to notify the user of the above contents, for example, a message meaning that “In preparation. Please wait for a while. This camera can be used with limited functions. Please supply fuel” is displayed. The system controller 22 selectively controls the operations of the digital camera 10 such that, even though an operation such as an electronic flash emitting operation which requires a peak electric power is requested from the user, the operation is not performed. At this time, for example, a message meaning that “the operation cannot be performed due to electric power shortage. Please wait for a while” is displayed on the liquid crystal monitor 32 to notify the user that the functions are limited. Whether the secondary battery 42 is charged to a predetermined level is checked by checking an output voltage from the secondary battery 42.

The system controller 22 may be configured such that contents to be selected may be changed depending on the charge state of the secondary battery 42 when the operations of the digital camera 10 are selectively controlled. More specifically, the system controller 22 obtains the state of the secondary battery 42 through the power supply monitor controller 50. At this time, not only digital information such as operable/inoperable but also information obtained by converting the output voltage from the secondary battery 42 by an analog-to-digital converter (not shown) may be transmitted to the system controller 22 by the power supply monitor controller 50. When a lithium-ion secondary battery is used as the secondary battery 42, the user can recognize a charge state on the basis of the output voltage from the secondary battery 42. By using the function, the following controls will be performed. That is, when the charge state of the secondary battery 42 is low with a small residual quantity of the battery, for example, light emission of the electronic flash is completely prohibited. However, when the charge state is high with a residual quantity of the battery which is sufficient to some extent, electric emission of the electronic flash is permitted at time intervals which are three times the normal intervals.

Case 7 is the case in which the base battery 40 is in a charge state, the secondary battery 42 is empty, and the fuel of the fuel cell 44 is filled up with fuel. In case 7, as in case 6, the fuel cell 44 is filled up with fuel, but the secondary battery 42 is empty. For this reason, all of the normal operations of the digital camera 10 cannot be performed. However, the digital camera 10 can be operated with limited functions. Case 7 is different from case 6 in that the fuel cell 44 is filled up with fuel. For this reason, for example, a message meaning that “In preparation. Please wait for a while. This camera can be used with limited functions” is displayed on the liquid crystal monitor 32.

Case 8 is the case in which the base battery 40 is in a charge state, the secondary battery 42 is in a charge quantity reduced state, and the fuel cell 44 is filled up with fuel. In case 8, since the fuel cell 44 is filled up with fuel and a charge quantity remains in the secondary battery 42, the digital camera 10 can be normally operated. In parallel to the normal operation, the secondary battery 42 is charged by electrical generation by the fuel cell 44.

Case 9 is the case in which the base battery 40 is in a charge state, the charge quantity of the secondary battery 42 is zero, and the fuel of the fuel cell 44 is empty. In case 9, in order to use the digital camera 10, fuel is added to the fuel cell 44, or an unused fuel cartridge is attached to operate the fuel cell 44 to generate electricity, and the secondary battery 42 must be charged by the electrical generating output. More specifically, the user must be urged to put fuel in the fuel cell 44. In this case, since the fuel of the fuel cell 44 serving as the main power supply of the digital camera 10 is empty, display on the liquid crystal monitor 32 cannot be performed. However, since the base battery 40 is in a charge state, the power supply monitor controller 50 is operated by the base battery 40. Therefore, as in cases 6 and 7, the power supply check switch 54 and the power supply check LED 56 are used for display. However, in this state, the power supply check LED 56 is designed to flicker in a cycle in which an on-off ratio is 2:1 when the power supply check switch 54 is turned on. It is written in the instruction of the digital camera 10 or presented on a part of the digital camera 10 body that the 2:1 flicker is a message which means that “please put fuel in” to notify the user of it.

Case 10 is the case in which all of the base battery 40, the secondary battery 42, and the fuel of the fuel cell 44 are empty. Case 10 is the case in which the digital camera 10 is left for a long period of time without being used, and the base battery 40 and the secondary battery 42 are naturally discharged. Since the base battery 40 is always charged by the secondary battery 42 in normal use, the state of case 10 rarely occurs. In this state, the power supply check LED 56 is kept in an off state even though the power supply check switch 54 is turned on. It is written in the instruction of the digital camera 10 or presented on a part of the digital camera 10 body that the off state of the LED means that “base battery is shut off” to notify the user of it.

When the charge quantity of the base battery 40 is zero, even though the fuel cell 44 is filled up with fuel, the digital camera 10 does not operate. Since the base battery 40 is a power supply which performs a minimum operation when the fuel of the fuel cell 44 runs out, the base battery 40 must be always charged to some extent. As countermeasures against the case, the base battery 40 is charged to the predetermined level by any one of (1) the base battery 40 is replaced with a charged base battery and (2) fuel is put in the fuel cell 44, and the fuel cell 44 is set in an electrical generation state to charge the secondary battery 42, after which the base battery 40 is charged Whether the base battery 40 is charged to the predetermined level is checked by checking an output voltage from the base battery 40 as in the checking operation for the secondary battery 42. In 1, above, the fuel of the fuel cell 44 is further supplied, and the secondary battery 42 is charged by the fuel cell 44. In this case, the digital camera 10 can be used. In 2, above, the base battery 40 is charged, and the secondary battery 42 is charged to a predetermined charge level described in case 6, i.e., the charge level at which the digital camera 10 can be operated. In this case, all the normal operations of the digital camera 10 can be performed. If the secondary battery 42 is not charged to the predetermined level, the digital camera 10 can be used with limited functions. The coping method is written on the instruction of the digital camera 10 or presented on a part of the digital camera 10 body to notify the user of the method.

Case 11 is the case in which both the base battery 40 and the secondary battery 42 are empty and the fuel cell 44 is filled up with fuel. Case 11 is a state in which the fuel of the fuel cell 44 is supplied in the state of case 10. The user must be kept waiting until the fuel cell 44 is operated to start electrical generation to charge the secondary battery 42 and the secondary battery 42 charges the base battery 40. Since the base battery 40 and the secondary battery 42 are empty, the power supply check LED 56 is kept in an off state. In this state, when the secondary battery 42 is charged, the state of the next case 12 is obtained.

Case 12 is the case in which the base battery 40 is empty, the secondary battery 42 is in a charge reduced state, and the fuel cell 44 is in a fuel reduced state. Case 12 is the case in which the fuel cell 44 generates electricity in the state of case 11 to charge the secondary battery 42 to some extent. Since the base battery 40 is empty, the digital camera 10 cannot be operated. The user must wait until the base battery 40 is charged by an electric power charged in the secondary battery 42. Whether the base battery 40 is charged to the predetermined level is checked by checking an output voltage from the base battery 40 as in the checking operation for the secondary battery 42.

Since display to be performed in this case cannot be operated by the system controller 22 because the base battery 40 is empty, the power supply check switch 54 and the power supply check LED 56 are used. As the power supply for the power supply monitor controller 50, the secondary battery 42 is used. When the power supply check switch 54 is turned on, the power supply check LED 56 is flickered in a cycle in which an on-off ratio is 1:1 (“LED flicker 1”). It is written in the instruction of the digital camera 10 or presented on a part of the digital camera 10 body that the 1:1 flicker is a message which means that “In preparation. Please wait for a while” to notify the user of it.

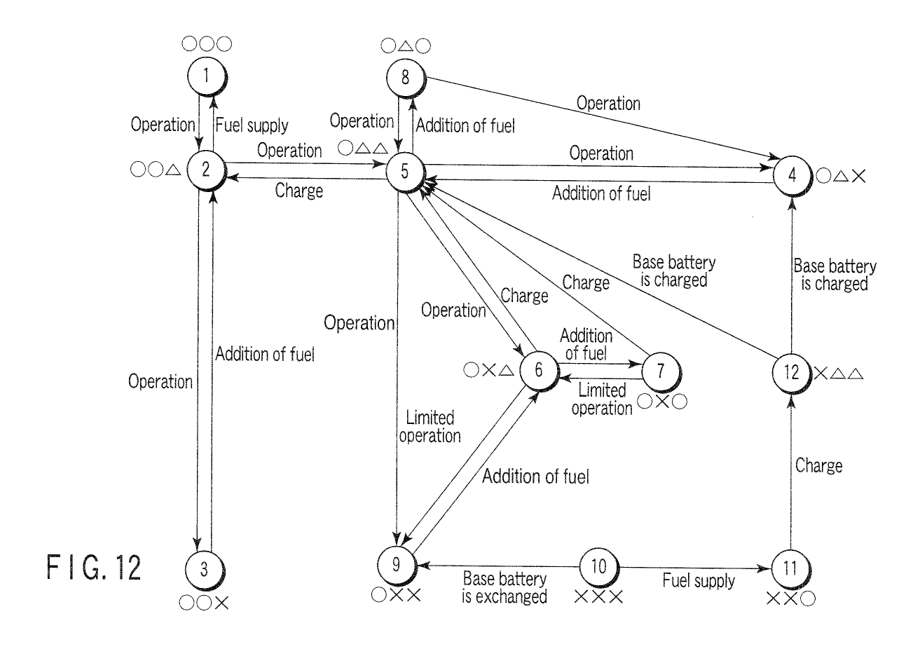

A mutual transition state between the states of case 1 to case 12 is shown in FIG. 12. In FIG. 12, encircled numbers correspond to case 1 to case 12, respectively. Symbols ◯, Δ, and X described beside the encircled numbers denote the state of the base battery 40, the state of the secondary battery 42, and the state of the fuel of the fuel cell 44, respectively. Words and terms written near arrows mean the followings.

“Operation” means that the digital camera 10 is operated.

“limited operation” means that limited operations (operations which do not use peak electric powers) of the digital camera 10 are performed.

“Charging” means that the fuel cell 44 charges the secondary battery 42.

“Addition of fuel” means that the fuel of the fuel cell 44 is added (before the fuel cell 44 is filled up).

“Supply of fuel” means that the fuel cell 44 is filled up with fuel.

The system controller 22 performs control of selection of a battery to be used by the digital camera 10, display on the liquid crystal monitor 32, and the like on the basis of the state transition diagram and the states of the fuel cell and the batteries obtained from the power supply monitor controller 50.

For example, the state of case 5 will be exemplified. Since case 5 is ◯ΔΔ, the base battery 40 is fully charged, the secondary battery 42 is charged halfway, and the fuel of the fuel cell 44 remains. In this state, when (A) the digital camera 10 is operated, depending on the states of the fuel of the fuel. cell 44 and the secondary battery 42, transition to the state of case 4 (◯ΔX), the state of case 6 (◯XΔ), or the state of case 9 (◯XX) occurs. (B) when fuel is supplied, the fuel cell 44 is filled up with fuel, and transition to the state of case 8 (◯Δ◯) occurs. Alternatively, (C) when the fuel cell 44 generates electricity to charge the secondary battery 42, transition to the state of case 2 (◯◯Δ) occurs.

On the other hand, transition to the state of case 5 occurs through any one of the routes given by (a) the case in which the digital camera 10 is operated to reduce the charge quantity of the secondary battery 42 in the state of case 2 (◯◯Δ), (b) the case in which fuel is added in the state of case 4 (◯ΔX), (c) the case in which the fuel cell 44 generates electricity to charge the secondary battery 42 and fuel remains in the state of case 6 (◯XΔ), (d) the case in which the fuel cell 44 generates electricity to charge the secondary battery 42 and fuel remains in the state of case 7 (◯X◯), (e) the case in which the digital camera 10 is operated in the state of case 8 (◯Δ◯), and (f) the case in which the fuel cell 44 generates electricity to charge the secondary battery 42 and the secondary battery 42 fully charges the base battery 40 in the state of case 12 (XΔΔ).

The system controller 22 controls the entire operation of the digital camera 10 by using an optimum power supply depending on the states of the power supplies, on the basis of the state transition diagram. When transition to a specific state occurs through a route which is not shown in the state transition diagram, some abnormality might have occurred in relation to the power supplies. In this case, the system controller 22 can cope with the abnormality.

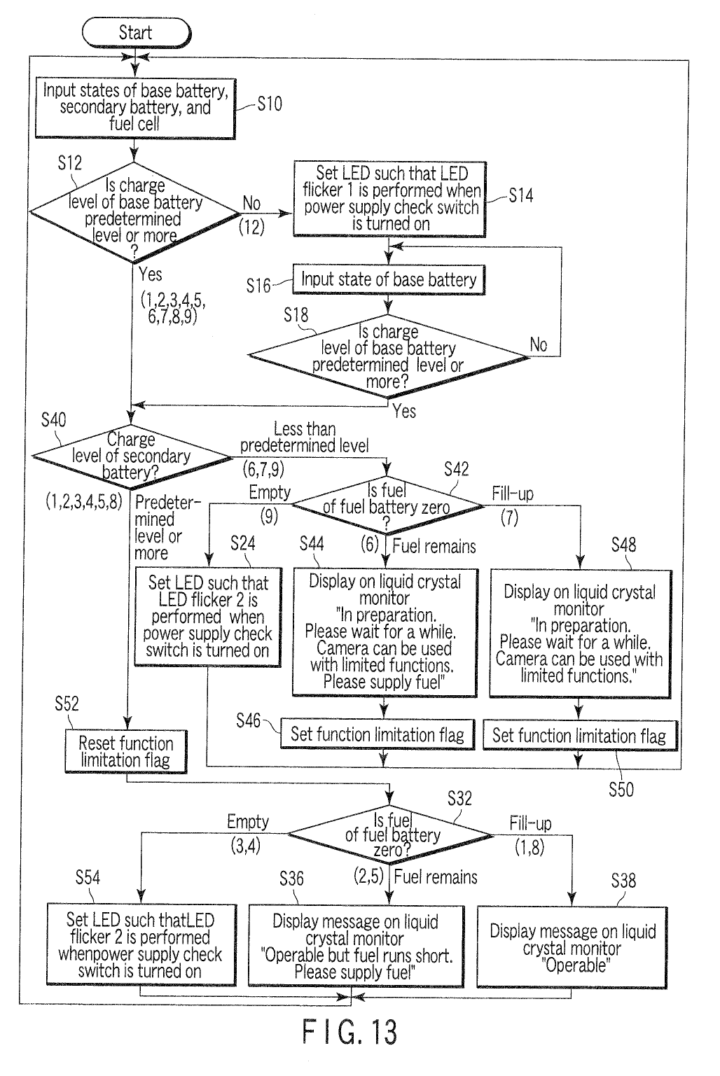

Operations of the power supply monitor controller 50 and the system controller 22 in the digital camera 10 serving as an electronic apparatus according to the embodiment will be described below in detail with reference to FIG. 13. Since the power supply monitor controller 50 operates by using the base battery 40 or the secondary battery 42 as a power supply, the states of case 10 and case 11 are excluded from the states shown in FIG. 11. Parenthetic numbers described in FIG. 13 correspond to the states shown in FIG. 11, respectively.

More specifically, as in the first embodiment, the states of the base battery 40, the secondary battery 42, and the fuel of the fuel cell 44 are taken in first (step S10). It is checked whether the charge level of the base battery 40 is a predetermined level or more (step S12).

When it is determined that the charge level of the base battery 40 is not the predetermined level or more, the power supply monitor controller 50 operates by the secondary battery 42, but must wait for a charging operation for the base battery 40. This state is the state of case 12. In this case, the power supply check LED 56 is set to be flickered by “flicker 1” such that the user is notified of an in-preparation state when the power supply check switch 54 is turned on (step S14). Thereafter, the state of the base battery 40 is taken in (step S16), and it is determined whether the charge state of the base battery 40 is at a predetermined level or more (step S18). In this case, when it is determined whether the charge state is not at the predetermined level or more, the power supply monitor controller 50 returns to step S16. In this manner, the power supply monitor controller 50 waits until the charge state of the base battery 40 is at the predetermined level or more.

When it is determined in step S18 that the charge state of the base battery 40 is at the predetermined level or more, or when it is determined in step S12 that the charge state of the base battery 40 is at the predetermined level or more (corresponding to the states of cases 1, 2, 3, 4, 5, 6, 7, 8, and 9), the charge state of the secondary battery 42 taken in step S10 is checked (step S40). When it is determined that the charge state of the secondary battery 42 is less than a predetermined level (corresponding to the states of cases 6, 7, and 9), the state of the fuel of the fuel cell 44 taken in step S10 is further checked (step S42).

In this case, when it is determined that the fuel is empty (corresponding to the state of case 9), the digital camera 10 has no power supply. For this reason, the power supply check LED 56 is set to be flickered by “flicker 2” to request the user “to supply fuel” when the power supply check switch 54 is turned on (step S24), and the controller returns to step S10.

In contrast to this, in step S42, when it is determined that the fuel of the fuel cell 44 is not filled up but remains (corresponding to the state of case 6), a message meaning that “In preparation. Please wait for a while. This camera can be used with limited functions. Please fill fuel up” is displayed on the liquid crystal monitor 32 (step S44). A function limitation flag is set to “1” (step S46), and the controller returns to step S10. When this function limitation flag is set to “1”, an operation such as light emission of the electronic flash or continuous photographing which requires a peak load electric power is not performed. The system controller 22 performs operation control when the system controller 22 detects the function limitation flag is set. The function limitation flag may be set in a memory (not shown) built in the system controller 22 or may be set in a memory (not shown) built in the power supply monitor controller 50. Alternatively, a predetermined area of the SDRAM 20 may be allocated as a flag area, or another dedicated memory may be set.

When it is determined in step S42 that the fuel cell 44 is filled up with fuel (corresponding to the state of case 7), a message meaning that “In preparation. Please wait for a while. This camera can be used with limited functions” is displayed on the liquid crystal monitor 32 (step S48), and the function limitation flag is set to “1” (step S50). Thereafter, the controller returns to step S10.

On the other hand, when it is determined in step S40 that the charge level of the secondary battery 42 is a predetermined level or more (corresponding to the states of cases 1, 2, 3, 4, 5, and 8), after the function limitation flag is reset to “0” (step S52), the state of the fuel of the fuel cell 44 taken in step S10 is checked (step S32).

In this case, when it is determined that the fuel is empty (corresponding to the state of cases 3 and 4), the digital camera 10 has no power supply For this reason, the power supply check LED 56 is set to be flickered by “flicker 2” to request the user “to supply fuel” when the power supply check switch 54 is turned on (step S54), and the controller returns to step S10.

In contrast to this, when it is determined in step S32 that the fuel of the fuel cell 44 is not zero, messages corresponding to residual quantities of the fuel are displayed on the liquid crystal monitor 32. More specifically, when the fuel is not filled up but remains (corresponding to the states of cases 2 and 5), a message meaning that “Operable but fuel runs short. Please supply fuel.” is displayed (sep S36). When the fuel cell 44 is filled up with fuel (corresponding to the states of cases 1 and 8), “Operable” is displayed (step S38). After the display is performed, the power supply monitor controller 50 returns to step S10 to perform operations corresponding to the states of the base battery 40, the secondary battery 42, and the fuel cell 44. At this time, it can be checked on the basis of the state transition diagram whether transition of the states occurs.

As described above, according to the second embodiment, in an electronic apparatus such as the digital camera 10 using the fuel cell 44 and the rechargeable secondary battery 42 as power supplies, an operation of the electronic apparatus and a power supply to be used are selected depending on the states of the fuel cell 44 and the secondary battery 42, and, at the same time, a message based on the states of the fuel cell 44 and the secondary battery 42 is displayed. Furthermore, even when both the fuel cell 44 and the secondary battery 42 cannot be operated, in addition to the fuel cell 44 and the secondary battery 42, the base battery 40 serving as a rechargeable emergency power supply to perform a minimum operation and the power supply monitor controller 50 and the power supply check LED 56 serving as emergency information display means are arranged, and the emergency power supply is configured to be always charged while the electronic apparatus operates. Therefore, the electronic apparatus can be efficiently operated. Furthermore, since a user can always know the states of the power supplies of the electronic apparatus, an appropriate countermeasure can be performed to make it possible to prevent the electronic apparatus from being unusable halfway due to battery shutoff.

The present invention has been described above with reference to the embodiments. However, the present invention is not limited to the above embodiments. Various changes and modifications of the present invention can be effected without departing from the spirit and scope of the invention, as a matter of course.

For example, in the first and second embodiments, the power supply check LED 56 is configured to display four cases by an on state, an off state, and two flicker patterns. The four cases may be displayed using a two-color (red and green) LED by a red light and a green light which are independently turned on, a yellow light obtained by simultaneously turning on both the colors, and an off state obtained by simultaneously turning off both the colors.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a fuel cell;
a first battery including a secondary battery configured to be rechargeable by the fuel cell, all operations of the electronic apparatus being performed by an electric power supplied from at least one of the fuel cell and the first battery;
a second battery configured to do not perform all the operations of the electronic apparatus but at least supply an electric power to enable detect battery residual quantities of the fuel cell and the batteries and display based on the detection result; and
a battery residual quantity detection unit configured to detect the battery residual quantities of the fuel cell and the first and second batteries, wherein
on the basis of the battery residual quantities detected by the battery residual quantity detection unit, the presence/absence of execution of a charging operation from the fuel cell to the first battery is determined, and at least one of a designation to supply fuel to the fuel cell and an operation state of the electronic apparatus is displayed on a first display, and
when the battery residual quantity of at least one of the fuel cell and the first battery is zero, an electric power is supplied from the second battery to the battery residual quantity detection unit to detect the battery residual quantities of the fuel cell and the batteries, and display based on the detection result is performed on a second display.

2. The electronic apparatus according to claim 1, wherein all the operations of the electronic apparatus are performed only by an electric power supplied from the first battery, and
the second battery includes a secondary battery configured to be rechargeable by an electric power supplied from the first battery.

3. The electronic apparatus according to claim 2, wherein when an electric power is not supplied to the battery residual quantity detection unit because the residual quantity of the first battery is zero, an electric power is supplied from the second battery to the battery residual quantity detection unit, in response to an operation of a switch arranged on the electronic apparatus, to detect the battery residual quantities of the fuel cell and the batteries, and display based on the detection result is performed on the second display.

4. The electronic apparatus according to claim 3, wherein the second display is an LED.

5. The electronic apparatus according to claim 4, wherein the fuel cell uses methanol as a fuel.

6. The electronic apparatus according to claim 3, wherein the fuel cell uses methanol as a fuel.

7. The electronic apparatus according to claim 2, wherein the second battery is always charged while the electronic apparatus operates.

8. The electronic apparatus according to claim 7, wherein the fuel cell uses methanol as a fuel.

9. The electronic apparatus according to claim 2, wherein the fuel cell uses methanol as a fuel.

10. The electronic apparatus according to claim 1, wherein all the operations of the electronic apparatus are performed by an electric power from the fuel cell only or by an electric power including an electric power from the fuel cell and an electric power from the first battery, and
the second battery includes a secondary battery configured to be rechargeable by the electric power supplied from the first battery.

11. The electronic apparatus according to claim 10, wherein when an electric power is not supplied to the battery residual quantity detection unit because the residual quantity of the fuel cell is zero, an electric power is supplied from the second battery to the battery residual quantity detection unit, in response to an operation of a switch arranged on the electronic apparatus, to detect the battery residual quantities of the fuel cell and the batteries, and display based on the detection result is performed on the second display.

12. The electronic apparatus according to claim 11, wherein the second display is an LED.

13. The electronic apparatus according to claim 12, wherein the fuel cell uses methanol as a fuel.

14. The electronic apparatus according to claim 11, wherein the fuel cell uses methanol as a fuel.

15. The electronic apparatus according to claim 4, wherein the second battery is always charged while the electronic apparatus operates.

16. The electronic apparatus according to claim 15, wherein the fuel cell uses methanol as a fuel.

17. The electronic apparatus according to claim 10, wherein the fuel cell uses methanol as a fuel.

18. The electronic apparatus according to claim 1, wherein the second display is an LED.

19. The electronic apparatus according to claim 18, wherein the fuel cell uses methanol as a fuel.

20. The electronic apparatus according to claim 1, wherein the fuel cell uses methanol as a fuel.
